(19) United States
(12) Patent Application Publication
(10) Pub. No.: US 2013/0092786 A1
(43) Pub. Date: Apr. 18, 2013

(54) INTERFEROMETRIC STRAIN FIELD SENSOR SYSTEM FOR MEASURING ROTOR STATE

(71) Applicant: Aaron Kellner, Bloomfield, CT (US)

(72) Inventor: Aaron Kellner, Bloomfield, CT (US)

(73) Assignee: SIKORSKY AIRCRAFT CORPORATION, Stratford, CT (US)

(21) Appl. No.: 13/272,843

(22) Filed: Oct. 13, 2011

(51) Int. Cl. B64C 27/54

(52) U.S. Cl. 244/17.13

(57) ABSTRACT

A system for controlling operation of a rotary-wing aircraft includes at least one optical interferometric sensor located at a selected point of measurement of a rotor assembly of the rotary-wing aircraft. An aircraft control system is operably connected to the at least one optical interferometric sensor to evaluate sensor data from the at least one optical interferometric sensor and alter operation of the rotary-wing aircraft based on the evaluation. A fiber optic rotary joint operably connects the at least one optical interferometric sensor to the aircraft control system.

### GOVERNMENT RIGHTS STATEMENT

This invention was made with Government support under Agreement No. W911W6-08-2-0004 for Adaptive Vehicle Management System (AVMS). The Government has certain rights in this invention.

### BACKGROUND OF THE INVENTION

The subject matter disclosed herein relates to rotors. More particularly, the present disclosure relates to sensor measurement systems for rotors of rotary-winged aircraft.

Rotor systems for rotary-winged aircraft, such as helicopters, are subjected to a wide variety of stress and strain conditions during flight operations. Typically, allowable operating conditions, the flight envelope, is established to limit helicopter operations such that stress or strain limits are not reached that would result in damage to the rotor system. To more closely monitor the health of the rotor and potentially expand the flight envelope in certain conditions, it would be advantageous to acquire measurements of stress, strain, and/or other indicators of rotor health during operation. Such measurements would typically be provided by an array of typical foil-type strain gauges affixed to the rotor, and utilizes a slip ring to allow transmission of data via wire from the rotating strain gauge location to the control system of the aircraft. Besides needing a slip-ring to facilitate data transmission, foil-type strain gauges have many drawbacks including short useful life, vulnerability to harsh environmental conditions found at the rotor and instrumental complexity at the measurement site.

### BRIEF DESCRIPTION OF THE INVENTION

A system for controlling operation of a rotary-wing aircraft includes at least one optical interferometric sensor located at a selected point of measurement of a rotor assembly of the rotary-wing aircraft. An aircraft control system is operably connected to the at least one optical interferometric sensor to evaluate sensor data from the at least one optical interferometric sensor and alter operation of the rotary-wing aircraft based on the evaluation. A fiber optic rotary joint operably connects the at least one optical interferometric sensor to the aircraft control system.

A rotary wing aircraft includes an airframe and a rotor assembly rotably disposed at the airframe. At least one optical interferometric sensor is located at a selected point of measurement of the rotor assembly. An aircraft control system is located at the airframe and is operably connected to the at least one optical interferometric sensor to evaluate sensor data from the at least one optical interferometric sensor and alter operation of the rotary wing aircraft based on the evaluation. A fiber optic rotary joint operably connects the at least one optical interferometric sensor to the aircraft control system.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic of an embodiment of a rotary wing aircraft;

FIG. 2 is a schematic view of an embodiment of a sensor for a rotary wing aircraft; and

FIG. 3 is an embodiment of a joint for transmission of a signal from a sensor for a rotary wing aircraft.

The detailed description explains embodiments of the invention, together with advantages and features, by way of example with reference to the drawings.

### DETAILED DESCRIPTION OF THE INVENTION

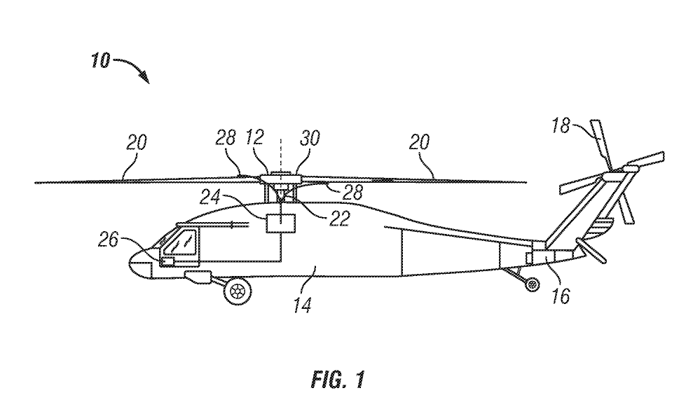

Shown in FIG. 1 is a schematic illustration of a rotary wing aircraft 10 having a main rotor assembly 12. The aircraft 10 includes an airframe 14 having an extending tail 16 at which is mounted an anti-torque rotor 18. Although the configuration illustrated is a helicopter, it is to be appreciated that other machines such as turbo-props and tilt-rotor aircraft will also benefit from the system of the present disclosure. The main rotor assembly 12 includes a plurality of rotor blades 20 located about a rotor shaft 22. The aircraft includes a control system 24 operably connected to the main rotor assembly 12, which controls operation of the main rotor assembly 12. The control system 24 receives input from, for example, a pilot via manipulation of flight controls 26 and from a plurality of sensors 28 located at the main rotor assembly 12. The sensors 28 are secured to, for example, a selected location at a rotor blade 20. Based on this input, the control system 24 may, for example, adjust a rotational speed of the main rotor assembly 12, change a pitch of the plurality of rotor blades 20 via a swash plate 30, and/or change a position of one or more control surfaces of the main rotor assembly 12. In some embodiments, the control system 24 is a fly-by-wire control system 24.

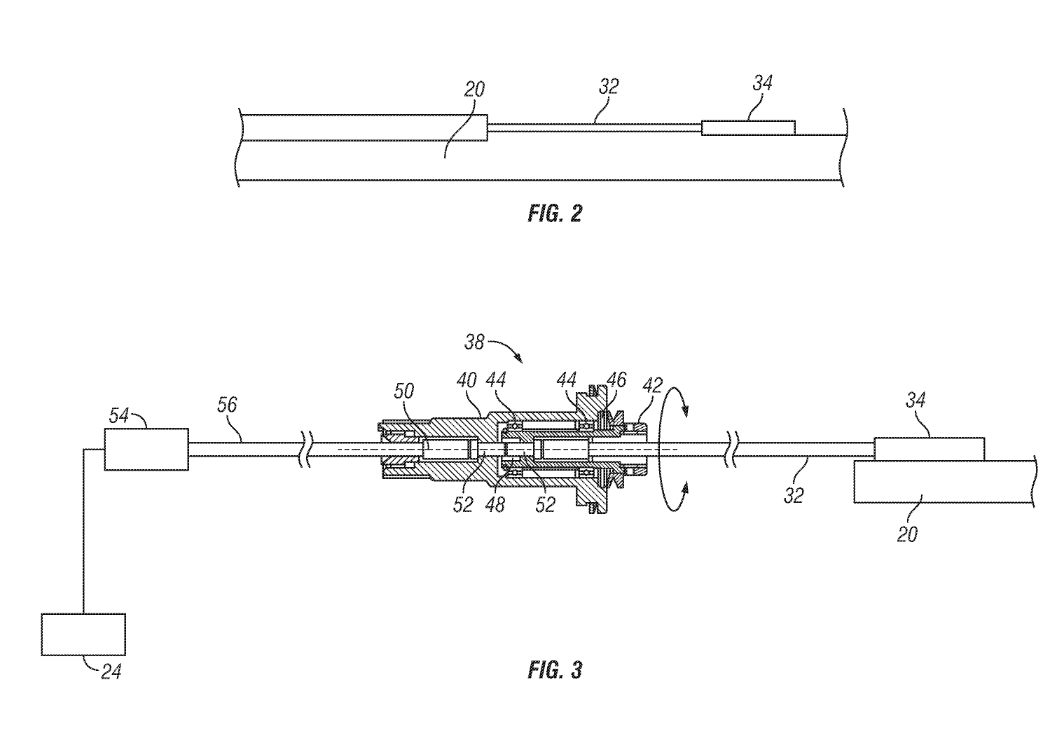

Referring now to FIG. 2, the sensor 28 includes a sensor lead 32 extending from a sensor tip 34, which is secured at a selected measurement location, for example a selected location of a rotor blade 20. The type of sensor tip 34 utilized is dependent on the type of measurement data desired. For example, a tip 34 configured as a Fabry-Perot interferometer may be utilized to measure strain at the measurement location. The sensor tip 34 described herein have improved durability and longer useful life compared to traditional foil-type strain gauges and are used to collect real time data and provide feedback to the control system 24 during aircraft 10 operations throughout the life of the aircraft 10.

To transmit the interferometric signal from the rotating main rotor assembly 12 to the control system 24 at the non-rotating airframe 14 a fiber-optic rotary joint (FORJ) 38, as shown in FIG. 3, is utilized. The FORJ 38 includes a female portion 40 located at the stationary airframe 14, and a male portion 42 extending from the main rotor assembly 12 and receivable by the female portion 40. The FORJ 38 includes one or more bearing assemblies 44 to support the male portion 42 at the female portion 40 and a lock mechanism 46 to secure the male portion 42 at the female portion 40 while allowing the male portion 42 to rotate relative to the female portion 40. The FORJ 38 secures the male portion 42 and the female portion 40 with a gap 48 between the two along a FORJ axis 50. The interferometric signal is transmitted across the gap 48 via a lens 52, for example a C-Type lens, located at each of the female end 40 and the male end 42 at the gap 50. The C-Type lens 52 has a relatively broad and flat spectral transmission range and improved signal to noise ratio over other alternatives. The FORJ 38 shown in FIG. 3 is single channel, with one male portion 42 and one female portion 40, but it is to be appreciated that a multi channel FORJ 38 may be utilized, with any number of male portions 42 inserted into a single non-rotating female portion 40.

The interferometric signal, as a spectrum of light, is transmitted from the FORJ 38 along a FORJ lead 56 to a signal processor 54. The signal processor 54 analyzes the signal from each sensor tip 34. For example, the signal processor 54 utilizes an LCD array to analyze the signals for peaks and nulls in the spectrum. The signals are filtered to remove and average noise, then the signals are analyzed by the signal processor 54 to determine strain and determine rotor blade 20 parameters such as flap, lead/lag, and blade 20 torsion. The resulting parameters are utilized by the control system 24 to determine changes to aircraft 10 control surfaces as desired.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A system for controlling operation of a rotary-wing aircraft comprising:
at least one optical interferometric sensor disposed at a selected point of measurement of a rotor assembly of the rotary-wing aircraft;
an aircraft control system operably connected to the at least one optical interferometric sensor to evaluate sensor data from the at least one optical interferometric sensor and alter operation of the rotary-wing aircraft based on the evaluation; and
a fiber optic rotary joint operably connecting the at least one optical interferometric sensor to the aircraft control system.

2. The system of claim 1, wherein the at least one optical interferometric sensor is at least one Fabry-Perot interferometer.

3. The system of claim 1, further comprising:
a sensor lead extending toward the at least one optical interferometric sensor from a first end of to the fiber optic rotary joint; and
a joint lead extending toward the aircraft control system from a second end of the fiber optic rotary joint.

4. The system of claim 3, wherein the sensor lead and the joint lead are disposed at the fiber optic rotary joint with a gap therebetween.

5. The system of claim 4, wherein an interferometric signal is transmittable across the gap.

6. The system of claim 4, wherein one or more of the sensor lead and the joint lead include a C-Type lens disposed facing the gap.

7. The system of claim 1, wherein the selected point of measurement is a rotor blade of the rotor assembly.

8. The system of claim 1, further comprising a signal processor operably connected to the at least one optical interferometric sensor and the aircraft control system.

9. The system of claim 8, wherein the signal processor includes an LCD array to analyze data obtained from the at least one optical interferometric sensor.

10. The system if claim 1, wherein the at least one optical interferometric sensor is a strain sensor.

11. A rotary wing aircraft comprising:
an airframe;
a rotor assembly rotably disposed at the airframe;
at least one optical interferometric sensor disposed at a selected point of measurement of the rotor assembly;
an aircraft control system disposed at the airframe and operably connected to the at least one optical interferometric sensor to evaluate sensor data from the at least one optical interferometric sensor and alter operation of the rotary wing aircraft based on the evaluation; and
a fiber optic rotary joint operably connecting the at least one optical interferometric sensor to the aircraft control system.

12. The rotary wing aircraft of claim 11, wherein the at least one optical interferometric sensor is at least one Fabry-Perot interferometer.

13. The rotary wing aircraft of claim 11, further comprising:
a sensor lead extending toward the at least one optical interferometric sensor from a first end of to the fiber optic rotary joint; and
a joint lead extending toward the aircraft control system from a second end of the fiber optic rotary joint.

14. The rotary wing aircraft of claim 13, wherein the sensor lead and the joint lead are disposed at the fiber optic rotary joint with a gap therebetween.

15. The rotary wing aircraft of claim 14, wherein an interferometric signal is transmittable across the gap.

16. The rotary wing aircraft of claim 14, wherein one or more of the sensor lead and the joint lead include a C-Type lens disposed facing the gap.

17. The rotary wing aircraft of claim 11, wherein the selected point of measurement is a rotor blade of the rotor assembly.

18. The rotary wing aircraft of claim 11, further comprising a signal processor operably connected to the at least one optical interferometric sensor and the aircraft control system.

19. The rotary wing aircraft of claim 18, wherein the signal processor includes an LCD array to analyze data obtained from the at least one optical interferometric sensor.

20. The rotary wing aircraft of claim 11, wherein the at least one optical interferometric sensor is a strain sensor.
